(19) United States
(12) Patent Application Publication
(10) Pub. No.: US 2026/0266595 A1
(43) Pub. Date: Sep. 10, 2026

(54) METHOD AND SYSTEM FOR EFFICIENT INSPECTION OF MANUFACTURING PART

(71) Applicant: TRIAD National Security, LLC, Los Alamos, NM (US)

(72) Inventors: Sarah Nicole Brown, Los Alamos, NM (US); Nathaniel Ray Morgan, Los Alamos, NM (US); Johnny Benny III Vigil, Los Alamos, NM (US); Andre Nicolas Bos, Los Alamos, NM (US); John David Bernardin, Los Alamos, NM (US)

(21) Appl. No.: 19/542,411

(22) Filed: Feb. 17, 2026

Related U.S. Application Data
(60) Provisional application No. 63/766,849, filed on Mar. 4, 2025.

(51) Int. Cl. G01B 11/24; G01B 5/012

(52) U.S. Cl. CPC G01B 11/24; G01B 5/012

(57) ABSTRACT

A system includes a measurement device that performs measurement associated with part features to generate a plurality of measured data. The system includes a processor that receives the measured data, manufacturing specification data associated with the part, and precision data associated with confidence level for inspection of the part. The processor performs a sequential model-based optimization by generating a surrogate function using the measured data and the manufacturing specification data. An acquisition function is based on the sequential model-based optimization of the surrogate function, identifying a region of the part to be inspected in a next iteration. The processor transmits control data for the region to cause the measurement device to perform measurements in the next iteration. The performing the optimization and transmitting the control data are repeated until an error exceeding a threshold specified in the manufacturing specification data is found or until the confidence level is reached.

### RELATED APPLICATIONS

The instant application is a nonprovisional application that claims the benefit and priority to the provisional application No. 63/766,849, filed on Mar. 4, 2025, which is incorporated herein by references in its entirety.

### ACKNOWLEDGMENT OF GOVERNMENT SUPPORT

This invention was made with government support under 89233218CNA000001 awarded by the National Nuclear Security Administration. The government has certain rights in the invention.

### BACKGROUND

Manufacturing parts are generally dimensionally inspected after they have been manufactured to ensure the accuracy and tolerance of the part for its intended application. For example, parts pass dimensional inspection if the largest measured error of the surface contour is less than the specified tolerance and those that fail inspection are discarded or require a disposition. The inspection process becomes more time consuming for parts that are more complex (e.g., geometrically complex) and/or for parts that need higher accuracy. For example, higher accuracy may be needed in medical devices, aviation device, satellite components, space components, etc., which may also be complex in nature. Efforts to inspect parts may include a traditional touch probe coordinate measuring machine (CMM) that may take a substantial amount of time to inspect a part, e.g., 8-10 hours depending on the complexity of the part or even days. In order to reduce the amount of time needed to inspect the part to enhance production, other technologies including optical and/or laser scanner have become prevalent, which are capable of rapidly acquiring data measurements for hundreds of thousands of points concurrently. Unfortunately, while optical scanning reduces the inspection time it deters from measurement precision and accuracy because of variability in measurement uncertainty within different scanners and measurement conditions and because of being highly susceptible to noise, e.g., introduced by electronic hardware, round-off errors in the data processing software, etc., and other environmental factors, e.g., surrounding light such as spurious light collected from highly reflective and angled surfaces and/or adverse ambient lighting condition, vibration, etc.

### SUMMARY

Accordingly, a need has arisen to perform measurements associated with a part (whether being in the process of manufacturing or whether post-manufacturing stage) intelligently to ensure accuracy and tolerance of the part while reducing the amount of time that is needed to make such measurements.

In some embodiments, a system may include a measurement device configured to perform measurement associated with one or more features of a part and to generate a plurality of measured data. The system may also include a processor configured to a) receive the plurality of measured data, b) receive manufacturing specification data associated with the part, c) receive precision data associated with confidence level for inspection of the part, d) perform a sequential model-based optimization, e.g., Bayesian, bandit, gradient descent, genetic algorithm, etc., by generating a surrogate function using the plurality of measured data and the manufacturing specification data, wherein an acquisition function based on the sequential model-based optimization of the surrogate function identifies a region associated with the part to be inspected in a next iteration, e) transmit control data associated with the region to cause the measurement device to perform measurements in the next iteration, and f) repeating steps (d) and (e) until an error exceeding a threshold specified in the manufacturing specification data is found or until the user-specified confidence level is reached.

These and other features and aspects of the concepts described herein may be better understood with reference to the following drawings, description, and appended claims.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 depicts an example of a diagram of a hardware-based system to perform part measurements according to one aspect of the present embodiments.

FIG. 2 depicts an example of a Bayesian optimization used to intelligently identify measurement points according to one aspect of the present embodiments.

FIG. 3 depicts an example of a part and a plurality of surrogate models generated according to one aspect of the present embodiments.

FIG. 4 depicts an example of comparison of part measurements associated with multiple techniques.

FIG. 5 depicts another example of comparison of part measurements associated with multiple techniques.

FIG. 6 depicts an example of comparison of part measurements associated with conventional system and numerical processing according to one aspect of the present embodiments.

FIG. 7 depicts an example of varying data points according to one aspect of the present embodiments as confidence interval changes.

FIG. 8 depicts an example of Bayesian optimization according one aspect of the present embodiments used to perform part measurement.

FIG. 9 depicts an example of a flow diagram for using numerical processing to perform part measurements according to one aspect of the present embodiments.

FIG. 10 depicts a block diagram of a computer system suitable for using numerical processing to perform part measurements in accordance with some embodiments.

### DETAILED DESCRIPTION

The following disclosure provides many different embodiments, or examples, for implementing different features of the subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Before various embodiments are described in greater detail, it should be understood that the embodiments are not limiting, as elements in such embodiments may vary. It should likewise be understood that a particular embodiment described and/or illustrated herein has elements which may be readily separated from the particular embodiment and optionally combined with any of several other embodiments or substituted for elements in any of several other embodiments described herein. It should also be understood that the terminology used herein is for the purpose of describing certain concepts, and the terminology is not intended to be limiting. Unless defined otherwise, all technical and scientific terms used herein have the same meaning as commonly understood in the art to which the embodiments pertain.

As described above, a need has arisen to perform part measurement (whether during manufacturing or post-manufacturing) intelligently to reduce the inspection time while achieving the desired precision and accuracy with a desired confidence level. In other words, a need has arisen to measure one or more features, e.g., geometrical dimensions, geometrical shapes, etc., of a part (either being manufactured or already manufactured) to ensure that the part is within a specified tolerance with a desired confidence level while reducing the amount of time that is needed to perform such part measurements. In one nonlimiting example, a numerical processing (sequential model-based optimization) such as Bayesian optimization, bandit optimization, etc., or algorithms such as gradient descent, genetic algorithm, etc., may be leveraged to intelligently identify optimal location(s) to perform measurements and to deliver statistical confidence that the part is within the specified tolerances. Leveraging numerical processing is in stark contrast with the conventional method where high precision measurements such as CMM is used to make accurate measurements of many points (e.g., brute-force point-to-point movements that take measurements at systematic pre-defined locations), thereby resulting in inefficiencies and consuming a long time to complete. The conventional approach has resulted in bottlenecks in the production process, increasing the overall cost. It is appreciated that leveraging numerical processing is also in stark contrast with a much faster conventional method of using scanning techniques, e.g., laser scanning, but suffer from precision and accuracy.

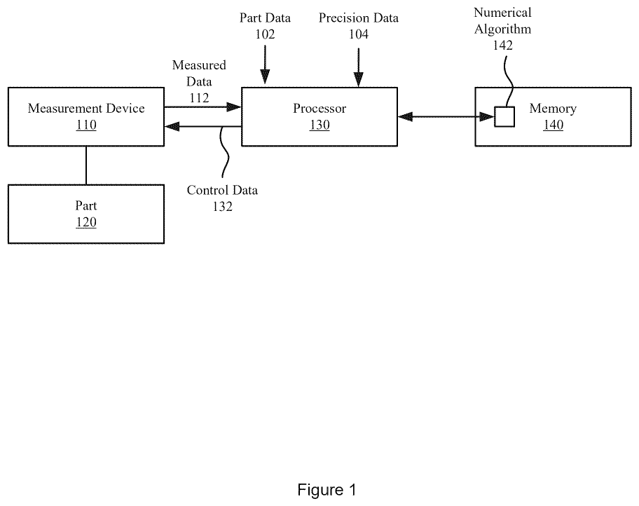

FIG. 1 depicts an example of a diagram of a hardware-based system to perform part measurements according to one aspect of the present embodiments. According to some embodiments, a part 120 may be a manufactured part (or a part that is being manufactured). The part 120 may have a particular shape, e.g., spherical, cylindrical, etc., depending on its application. The measurement device 110 is configured to measure one or more features of the part 120. The features may include geometrical shape, size, dimension, diameter, thickness, curvature, angle, smoothness, roughness, etc., associated with the part 120. The measurement device 110 may be an optical measuring device, e.g., a laser device, etc., or it may be a contact probe device, e.g., CMM, etc., or any combination thereof. It is appreciated that instead of making measurements on an exhaustive number of measuring locations on the part 120, the measurement device 110 only utilizes a subset of those measuring locations to measure one or more features of part 120 to generate the measured data 112. It is appreciated that since the number of measurements (e.g., measurement points) is reduced, the amount of time for the measurement is also reduced. The measured data 112 may be sent to a processor 130 for processing. The processor 130 also receives part data 102, e.g., dimensions, size, geometrical shape, diameter, thickness, curvature, angle, smoothness, roughness, etc. (hereinafter referred to as manufacturing specification) from a user, of the desired part 120 as well as precision data 104 indicating the desired precision levels for the part 120. It is appreciated that the part data 102 may be the computer aided design (CAD) modeling of the part 120, in one nonlimiting example. The processor 130 may access a numerical algorithm 142 (sequential model-based optimization), e.g., Bayesian algorithm, from the memory 140 in order to perform numerical processing on the measured data 112. It is appreciated that Bayesian algorithm and Bayesian optimization is described for illustrative purposes only and should not be construed as limiting the scope of the embodiments. For example, other types of algorithms such as bandit, gradient descent, genetic algorithm, etc., may be used to perform numerical processing on the measured data 112.

According to one nonlimiting example, the processor 130 processing the measured data 112 based on the Bayesian algorithm, the part data 102, and the precision data 104, defines a dimensional error as an objective function. The objective function may be the absolute value of the measured part contour (e.g., derived or measured by the measured data 112) subtracted from the desired part contour (e.g., derived or determined by the part data 102) at a location (e.g., a random location) on the part 120. In other words, the objective function is designed to capture the dimensional error by taking the absolute difference between the measured part 120 contour and the desired part 120 contour (as received by part data 102). It is appreciated that there may be a measurement (not performed yet) that would indicate that the part 120 is out of specification (e.g., error exceeds the precision needed as determined by the precision data 104) since the objective function (dimensional error) does not have a known analytic form and it has a local maxima that may or may not coincide with the global extrema. The precision data 104 may be the confidence level that is desired and may be user selectable. It is appreciated that the inspection software executed by the processor 130 utilizes Bayes theorem to identify the global maximum error using Bayesian optimization that is not only efficient (consumes less time than the conventional system) but is also within a desired confidence level, e.g., uncertainty bounds such as 2σ (95%) confidence or 3σ (99.7%), that the part 120 meets the manufacturing specification. In other words, the inspection software may search through many local maximas intelligently to find the global extremum where the part 120 may be most out of tolerance. It is appreciated that Bayesian optimization may be used to find the global optima (i.e., the locations that are most out of tolerance) in as few iterations (measurements) as possible.

The processor 130 is configured to generate a surrogate function to create and provide an estimate (calculation) of the actual objective function. The surrogate function converges toward the actual objective function with increasing number of samplings of objective function. The processor 130 is configured to initially generate a surrogate function based on the measured data 112 (e.g., based on laser scanning, CMM with random sampling of the part 120, coarse structured sampling of the part 120, etc.). The initially generated surrogate function is used by an acquisition function of the processor 130 to identify one or more regions of the part 120 to measure (e.g., sample the objective function) that have a higher probability of finding the largest error in the part 120.

The identified regions (or positioned) are sent to the measurement device 110, as control data 132, to control the operation of the measurement device 110 to cause the measurement device 110 to measure points within the identified regions because those identified regions have a higher probability of containing the largest error in the part 120. As such, the global optima may be found in as few iterations as possible. In one nonlimiting example, the control data 132 may control a robotic arm to change the positioning of the measurement device 110 or may control a lever upon which the measurement device is installed on to measure and sample points on identified regions of the part 120. As such, additional sampling (measurement) in the identified regions, reduces the uncertainty in knowing the actual part dimensions. It is appreciated that the measurement device 110 performs the measurements on the identified regions and sends the additional measured data to the processor 130.

The processor 130 repeats the process again to update the surrogate function/acquisition function in order to identify updated regions that have a higher probability of containing the largest error in the part 120. It is appreciated that the process repeats until a desired level of confidence based on the precision data 104 is achieved or until an error is found that exceeds the manufacturing specifications. In other words, the surrogate model gets updated every time a new measurement is taken. Therefore, the surrogate model becomes progressively more accurate over time. Once the surrogate model is generated, it is used by an acquisition function to identify regions that are most likely to contain largest errors if a measurement is taken there. Accordingly, it is more efficient to sample regions with a high probability of finding the largest error while also doing so in a way that reduces the uncertainty of the actual part inspection results. Thus, the global optima may be found in as few iterations as possible. According to one nonlimiting example, these steps are then placed in a loop: (1) construct the surrogate model from the measured CMM data points and/or scanning data points (e.g., laser), (2) use an acquisition function to search the surrogate model for the point where the CMM should probe next and output this location, (3) use the CMM to measure the location that was output in the previous step, (4) add the newly measured point to the data set that gets used to construct the surrogate model, and (5) repeat this loop until satisfied (an error exceeding the acceptable error is found or until the confidence level associated with the Bayesian optimization is achieved). It is appreciated that the loop is terminated when the tolerance is within a desired range given the specified confidence level by precision data 104.

Accordingly, the numerical processing results in a faster determination of whether the part 120 passes or fails by sampling fewer points on the part 120 in an intelligent fashion, as described above, but it can also be used to determine the confidence level associated with the determination. It is appreciated that the numerical processing, e.g., Bayesian optimization, as described above enables a quicker measurement approach, which may be a combination of fast but less accurate scans such as laser scanning with a slow but more accurate measurement such as CMM. It is further appreciated that the numerical processing such as Bayesian optimization, as described above, may be used in combination with slow but accurate measurements such as CMM to intelligently converge on regions of interest, e.g., regions with higher probability of error, in order to reduce the amount of time required to inspect the part 120 (reduce the number of iterations as much as possible). As such, the part 120 may be inspected intelligently (by actively learning about the part and regions with high confidence bounds that requires fewer probe points than those with lower confidence bounds where defects might be located) to reduce the overall number of probed points as opposed to brute force or inaccurate but fast scanning technique of the past, to verify the manufacturing specification based on the precision/confidence level that is needed to determine whether the part is within the specified tolerance or not in order to pass or fail the part.

It is appreciated that the system, as described above, may be extended to parts being manufactured (i.e., during the manufacturing process and before completion of manufacturing the part). As an example, when machining high-value parts, it may be crucial to manufacture them within tolerance every time. During traditional manufacturing processes, parts are machined and inspected in different facilities. Geometrical errors in the part can be generated during manufacturing by tool wear, system misalignment, and other factors. If the in-process inspection system can evaluate the part as in or out of tolerance before further inspection is performed, time and money could be saved. As such, the numerical processing may be applied during the manufacturing process, e.g., additive manufacturing process or subtractive manufacturing process, to determine whether the part has fallen outside of the manufacturing specification, at which point the remainder of manufacturing of that part may be aborted and the part may be discarded, thereby reducing waste (timewise and material-wise) to carry out the rest of the manufacturing process and going through the inspection process before determining that the part does not comply with the manufacturing specifications.

In one nonlimiting example, a computer numerical control (CNC) lathe with a robotic arm and sensor may be used to inspect the part 120 during the manufacturing process. Accordingly, corrective action may be taken to address imperfections with respect to the part 120 being manufactured during the manufacturing process. It is appreciated that taking corrective action may include actions to address imperfections in order to ensure that the part 120 being manufactured will be within the manufacturing specifications, thereby saving material and time as well as reducing disposed parts. Additionally, inspection of the part during the manufacturing process may reveal that the imperfection is unfixable, at which point the manufacturing process with respect to that part is stopped, thereby reducing waste of additional material that would otherwise be used to complete the manufacturing of the part. Moreover, valuable time is not spent on inspecting the part post-manufacturing, thereby saving time and resources from being spent on unfixable parts. Moreover, inspection of the part during the manufacturing process saves additional time by eliminating any post-inspection on the part (if the part is unfixable), thereby saving time and resources.

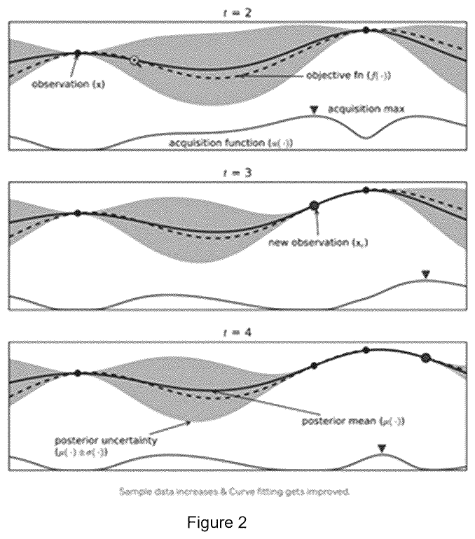

FIG. 2 depicts an example of a Bayesian optimization used to intelligently identify measurement points according to one aspect of the present embodiments. This nonlimiting example, the objective function that is unknown is shown. However, measurements whether random or preselected, can be done, as described above, to generate a surrogate function. The acquisition function may be generated based on the surrogate function. The new measurements based on the acquisition function may be made to form a new surrogate function and update the acquisition function. The process may be repeated a number of times until an error exceeding the acceptable error is found or until the confidence level associated with the Bayesian optimization is achieved. Accordingly, instead of brute force measurement of various point associated with the part, a small subset of points is first measured and based on that regions of interests are identified, thereby intelligently measuring points associated with the part. Therefore, the number of measurements is reduced making the inspection process faster as well as achieving the desired precision and confidence.

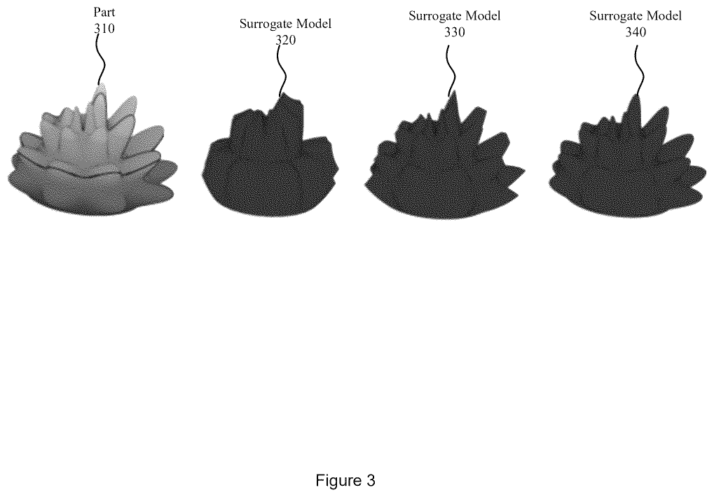

FIG. 3 depicts an example of a part and a plurality of surrogate models generated according to one aspect of the present embodiments. Part 310 is shown for illustration purposes. Surrogate model 320 illustrates the surrogate function created for the part 310 with 15° structured sweep (144 total measurements) was performed. In this nonlimiting example, the surrogate model has an amorphous representation because of the small sampling size that was used to estimate the surface. Surrogate models 330 and 340 show the surrogate function created for the part 310 with 6° (900 total measurements) and 2° (8100 total measurements) sweeps respectively. As illustrated, the more granular the sweep, the total number of measurements increase, and the more accurate the surrogate function gets in estimating the features of the part 310.

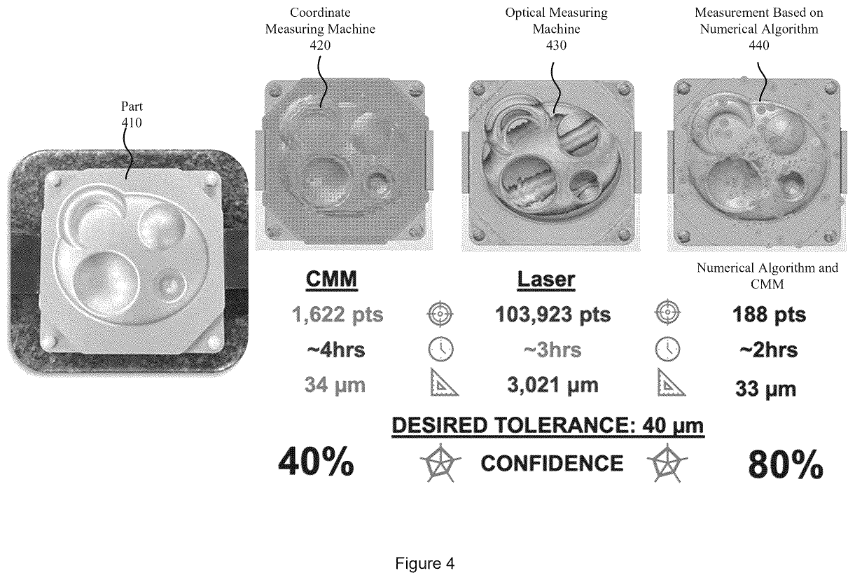

FIG. 4 depicts an example of comparison of part measurements associated with multiple techniques. In FIG. 4, a nonlimiting example of a part 410 is shown. Using CMM 420 techniques the part 410 is inspected with 1622 probe points that takes approximately 4 hours to complete with precision of 34 μm. In contrast, optical measuring machine 430 technique such as laser may perform measurements on 103,923 points that takes approximately 3 hours to complete with precision of 3021 μm. In contrast, measurement based on numerical processing algorithm 440 such as Bayesian optimization, as described in FIGS. 1-3, requires 188 points that takes approximately 2 hours to complete with the precision of 33 μm. Not only fewer points of inspections are needed for the same precision, but the inspection is performed in a much less time in comparison to the other methodologies.

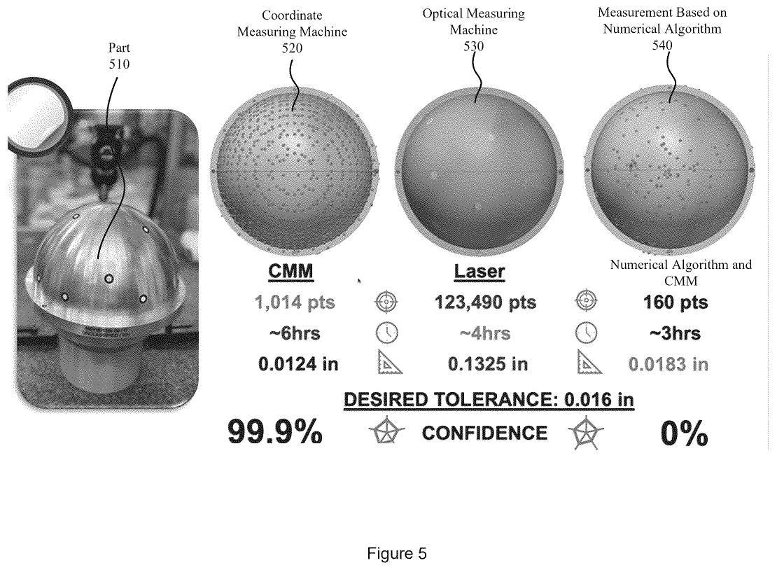

FIG. 5 depicts another example of comparison of part measurements associated with multiple techniques. In FIG. 5, a nonlimiting example of a part 510 is shown. Using CMM 520 techniques the part 510 is inspected with 1014 probe points that take approximately 6 hours to complete with precision of 0.0124 inches. In contrast, optical measuring machine 530 technique such as laser may perform measurements on 123,490 points that take approximately 4 hours to complete with precision of 0.1325 inches. In contrast, measurement based on numerical processing algorithm 540 such as Bayesian optimization, as described in FIGS. 1-3, requires 160 points that take approximately 2 hours to complete with the precision of 0.0183 inches. Not only fewer points of inspections are needed for the same precision, but the inspection is performed in a much less time in comparison to the other methodologies.

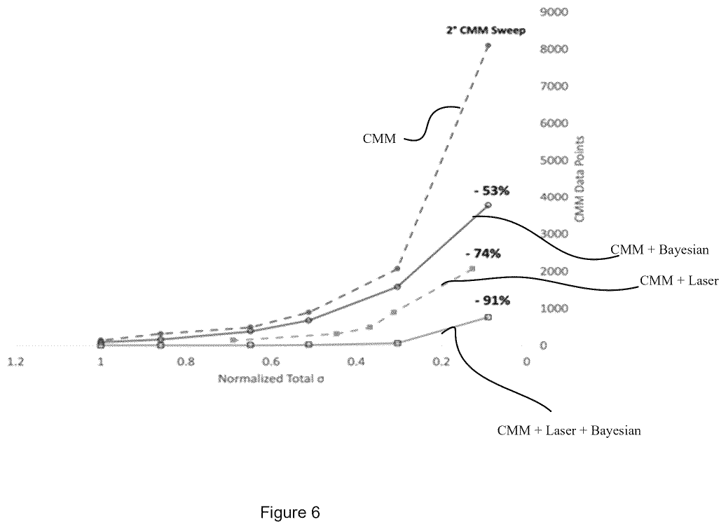

It is appreciated that one or more data measurement methods may be used, e.g., laser, CMM, or a combination thereof. In one nonlimiting example, laser scanning may be used to measure initial data while a CMM may be used to more accurately measure data based on the numerical processing. In other words, a combination of laser and CMM may be utilized in conjunction with numerical processing to perform inspection not only in a timely fashion but also accurately. Comparison of performance by using CMM only, CMM and Bayesian, CMM and laser, and CMM with laser and Bayesian, are shown in FIG. 6 for illustrative purposes.

FIG. 6 depicts an example of comparison of part measurements associated with conventional system and numerical processing according to one aspect of the present embodiments. For illustration purposes, four different test cases were performed to highlight the capabilities of the Bayesian optimization part inspection software compared to traditional approaches. In the example of FIG. 6, the outer contour of the part is being inspected for illustrative purposes and should not be construed as limiting the scope of the embodiments. For example, in some embodiments, the inner contour or the wall thickness may similarly be inspected. For comparison purposes, a conventional methodology to inspect a part is by using only the CMM device to generate samples (measurement points on the part) by performing a uniform sweep of data points. The conventional methodology reveals how the amount of normalized total standard deviation changes with respect to the number of CMM data points sampled. As expected, the standard deviation decreases as the number of CMM data points increases. The lowest standard deviation was achieved at 8100 CMM data points, corresponding to a 2° sweep. A combination of CMM and the Bayesian optimization used to inform the CMM device where to sample (to inspect the part efficiently) reveals that the Bayesian optimization software achieved the same amount of error as the 2° CMM sweep with only 3777 CMM data points. This corresponds to a 53% reduction in the total number of CMM data points compared to the traditional inspection process outlined in the conventional system of using only CMM data points. As a comparison, one conventional system may leverage a combination of CMM and laser approach such that cheap (but noisy) laser data is used in combination with the expensive (but accurate) CMM data. The laser was used to perform a 2° uniform sweep on the part with a high amount of uncertainty, and the CMM data were added to improve the accuracy of the measurements. The accuracy of the laser data in combination with the CMM data was accounted for in the calculation of the standard deviation and reveals that a 2° uniform laser sweep plus a 4° uniform CMM sweep achieved a similar amount of error as the 2° CMM sweep. This corresponds to a 74% reduction in the total number of CMM data points compared to the traditional inspection process outlined in the case that uses only CMM. Finally, a combination of Bayesian optimization may be used to inform the CMM device where to sample given the 2° uniform laser sweep data as an initial input and reveals that the Bayesian optimization software with the laser data achieved the same amount of error as the 2° CMM sweep but in only 768 CMM data points. This corresponds to a 91% reduction in the total number of CMM data points compared to the traditional inspection process outlined in the first case.

As illustrated, the Bayesian optimization software can perform an efficient part inspection process by selectively sampling points that have a high “payoff” value. By sampling points in this manner, the software is able to reduce the number of expensive CMM data sampling points by up to 91% (when the laser data were included) as compared to the conventional brute-force approach. The addition of the cheap laser data, in one nonlimiting example, allows the Bayesian optimization software to have a better initial prediction of what the surrogate model should look like, thereby improving the ability of the software to efficiently search the space without large unknown data regions.

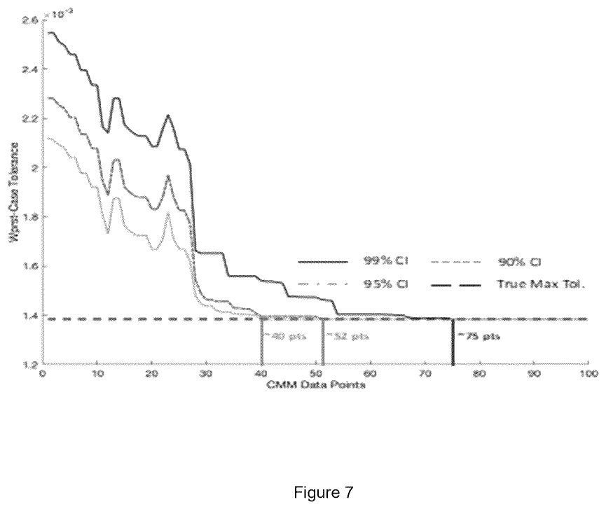

FIG. 7 depicts an example of varying data points according to one aspect of the present embodiments as confidence interval changes. FIG. 7 illustrates the use of laser data as the initial input into the Bayesian optimization software with the goal of efficiently sampling the part (a manufactured hemisphere with a region of outside of the tolerance range) to find the small region that is out of tolerance. The more points the laser identifies within this region, the more effective the software is at finding the out-of-tolerance location. Even if the accuracy of laser scrubs out all identifiable points, the global search algorithm in the software still finds the out-of-tolerance point with a few more iterations. FIG. 7 illustrates the minimum number of CMM data points that the software required to achieve a certain confidence level that the predicted worst-case tolerance matched the tolerance of the actual imperfection on the part. For example, if the confidence level is 90%, then the part was within the predicted worst-case tolerance with only 40 CMM data points until the software's prediction converges on the exact result. If the confidence level is selected to be 95%, then the part is within the predicted worst-case tolerance with only 52 CMM data points for convergence. As yet another nonlimiting example, if the confidence level is selected to be 99%, then the part is within the predicted worst-case tolerance with 75 CMM data points for convergence. This trend follows expected behavior—a higher confidence level should require more data points to be sampled. In addition, these results highlight the ability of the Bayesian optimization inspection software to find small impurities that traditional inspection processes might miss.

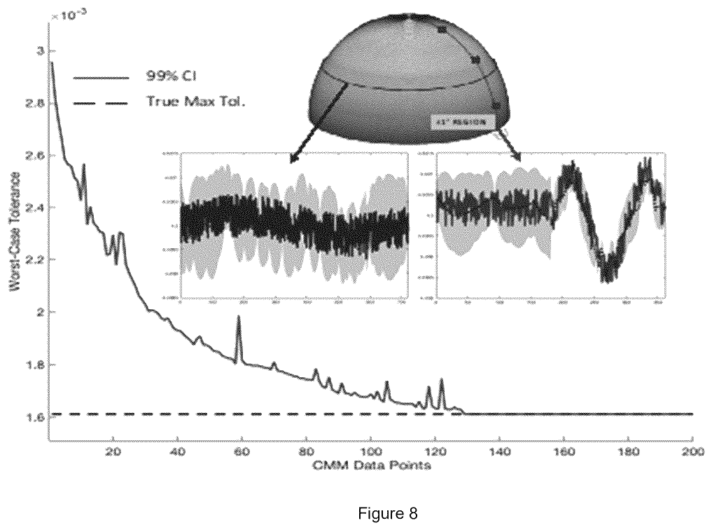

FIG. 8 depicts an example of Bayesian optimization according one aspect of the present embodiments used to perform part measurement. To create a more realistic scenario, with imperfections of smoothness and continuity of surfaces, noise has been added (in longitudinal and latitudinal directions). The Bayesian optimization software was run with a 99% confidence interval and converged to the exact result in approximately 130 CMM data points. Although the added noise required slightly more CMM data points to converge, the dashed lines in each subplot reveal that the Bayesian optimization software was still capable of fitting an appropriate surrogate model to the surface of the part (hemisphere) being inspected. It is appreciated that the Bayesian optimization software can perform an efficient part inspection process even in the presence of noisy data.

As described above with respect to FIGS. 1-8, the inspection process leveraging a numerical processing methodology such as Bayesian optimization results in a much faster inspection time during subtractive or additive manufacturing processes to identify errors early and for appropriate actions to be taken to fix those errors, if possible, to improve the quality of the part and to eliminate production waste. It is appreciated that the inspection process leveraging a numerical processing methodology such as Bayesian optimization may be used to intelligently inspect a part after the part is manufactured in a much faster pace in comparison to the conventional methodology by reducing the number of inspection points while maintaining the accuracy/precision within a desired confidence level. It is appreciated that the methodology, as described above, leveraging Bayesian optimization may also be used to inspect parts (e.g., cylindrical pins and sleeves) and to match them accordingly. For example, mating parts from large lots may be inspected to identify “pairs” that will best mate up and “pairs” that do not fit within a desired profile or tolerance (e.g., some pins are too wide to fit in some narrower sleeves, some pins will be sloppy in oversized sleeves, etc.). As such, the software utilizing Bayesian optimization may intelligently pair up parts for best fit. As yet another nonlimiting example, the software utilizing Bayesian optimization may ensure that the part is optimized with accessible features to enable more complete and accurate dimensional inspection. In yet another nonlimiting example, the software using Bayesian optimization may dictate the type of inspection, e.g., laser, CMM, laser and CMM, etc., to be performed given the design and dimensional/fit requirements. In yet another nonlimiting example, photogrammetry may be used with the software that uses Bayesian optimization to rapidly inspect a part. For example, an image of the part obtained from photogrammetry may be used to create a rough 3-dimensional model and the software may create an intelligently informed inspection process, as described above, using the knowledge of the 3-dimensional model and the available inspection tools.

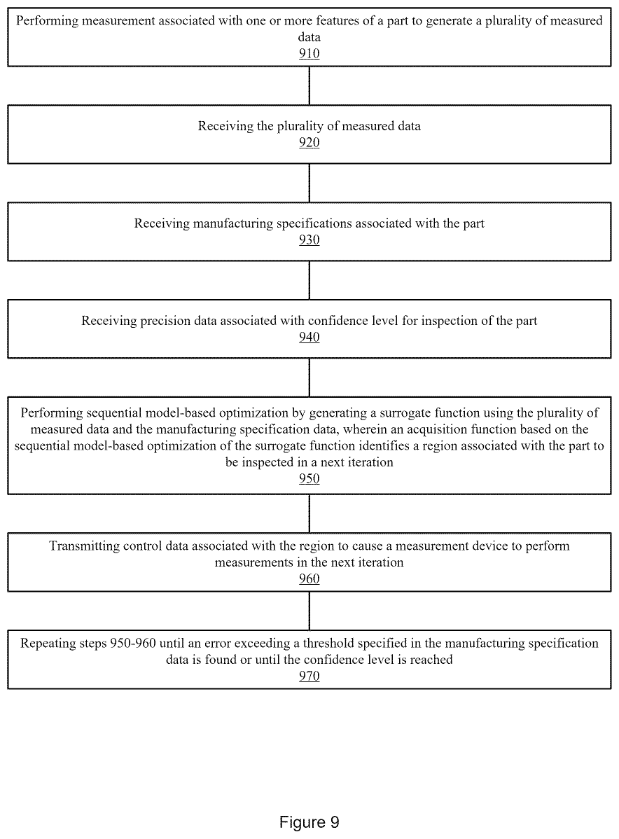

FIG. 9 depicts an example of a flow diagram for using numerical processing to perform part measurements according to one aspect of the present embodiments. Although the figure depicts functional steps in a particular order for purposes of illustration, the processes are not limited to any particular order or arrangement of steps. One skilled in the relevant art will appreciate that the various steps portrayed in this figure could be omitted, rearranged, combined and/or adapted in various ways. At step 910, measurement associated with one or more features of a part is performed to generate a plurality of measured data, as described above in FIGS. 1-8. At step 920, the plurality of measured data is received, as described above. At step 930, manufacturing specification associated with the part is received, e.g., CAD file, etc., as described above. At step 940, a confidence level associated with inspection of the part is received, as described above, e.g., via precision data 104. At step 950, Bayesian optimization is performed by generating a surrogate function using the plurality of measured data and the manufacturing specifications, as described above. An acquisition function based on the Bayesian optimization of the surrogate function identifies a region associated with the part to be inspected in a next iteration, as described in FIGS. 1-8. At step 960, control data associated with the region is transmitted to cause a measurement device to perform measurements in the next iteration, as described above. At step 970, steps 950-960 are repeated until an error exceeding a threshold specified in the manufacturing specifications is found or until the confidence level is reached.

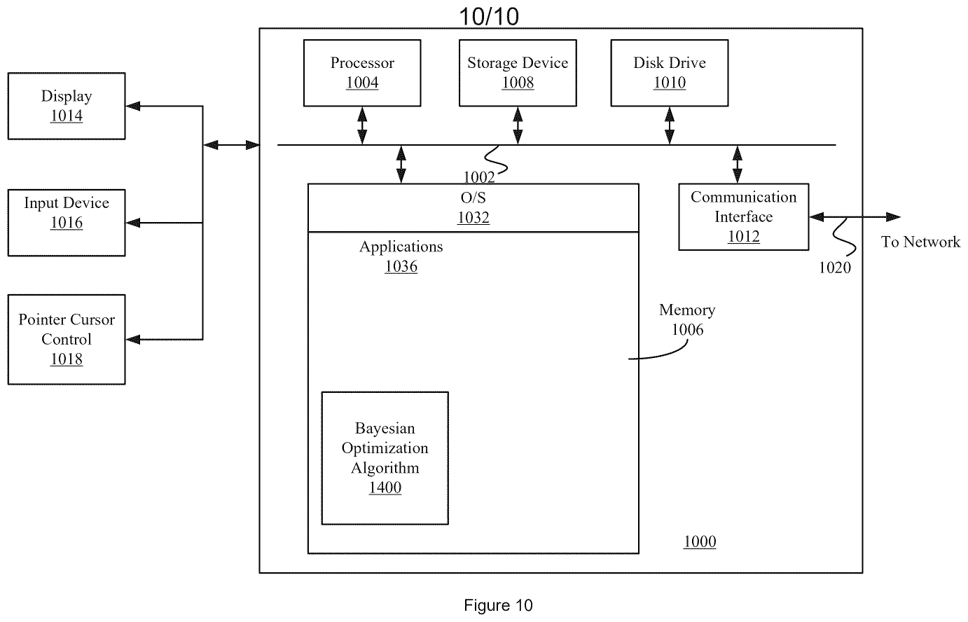

FIG. 10 depicts a block diagram of a computer system suitable for using numerical processing to perform part measurements in accordance with some embodiments. In some examples, computer system 1000 can be used to implement computer programs, applications, methods, processes, or other software to perform the above-described techniques and to realize the structures described herein. Computer system 1000 includes a bus 1002 or other communication mechanism for communicating information, which interconnects subsystems and devices, such as a processor 1004, a system memory (“memory”) 1006, a storage device 1008 (e.g., ROM), a disk drive 1010 (e.g., magnetic or optical), a communication interface 1012 (e.g., modem or Ethernet card), a display 1014 (e.g., CRT or LCD), an input device 1016 (e.g., keyboard), and a pointer cursor control 1018 (e.g., mouse or trackball). In one embodiment, pointer cursor control 1018 invokes one or more commands that, at least in part, modify the rules stored, for example in memory 1006, to define the electronic message preview process.

According to some examples, computer system 1000 performs specific operations in which processor 1004 executes one or more sequences of one or more instructions stored in system memory 1006. Such instructions can be read into system memory 1006 from another computer readable medium, such as static storage device 1008 or disk drive 1010. In some examples, hard-wired circuitry can be used in place of or in combination with software instructions for implementation. In the example shown, system memory 1006 includes modules of executable instructions for implementing an operating system (“OS”) 1032, applications 1036 (e.g., a host, server, web services-based, distributed (i.e., enterprise) application programming interface (“API”), program, Bayesian optimization algorithm 1400, procedure or others). Applications 1036 includes a Bayesian optimization algorithm 1400 configured to identify regions of the part to be inspected next. As described above. Communication interface 1012 is configured to send the one or more queries via communication link 1020 through a network to server 118 configured to process the one or more queries.

The term “computer readable medium” refers, at least in one embodiment, to any medium that participates in providing instructions to processor 1004 for execution. Such a medium can take many forms, including but not limited to, non-volatile media, volatile media, and transmission media. Non-volatile media includes, for example, optical or magnetic disks, such as disk drive 1010. Volatile media includes dynamic memory, such as system memory 1006. Transmission media includes coaxial cables, copper wire, and fiber optics, including wires that comprise bus 1002. Transmission media can also take the form of acoustic or light waves, such as those generated during radio wave and infrared data communications.

Common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, electromagnetic waveforms, or any other medium from which a computer can read.

In some examples, execution of the sequences of instructions can be performed by a single computer system 1000. According to some examples, two or more computer systems 1000 coupled by communication link 1020 (e.g., LAN, PSTN, or wireless network) can perform the sequence of instructions in coordination with one another. Computer system 1000 can transmit and receive messages, data, and instructions, including program code (i.e., application code) through communication link 1020 and communication interface 1012. Received program code can be executed by processor 1004 as it is received, and/or stored in disk drive 1010, or other non-volatile storage for later execution. In one embodiment, system 1000 is implemented as a hand-held device. But in other embodiments, system 1000 can be implemented as a personal computer (i.e., a desktop computer) or any other computing device. In at least one embodiment, any of the above-described delivery systems can be implemented as a single system 1000 or can be implemented in a distributed architecture including multiple systems 1000.

In some examples, execution of the sequences of instructions can be performed by a single computer system. According to some examples, two or more computer systems coupled by communication link (e.g., LAN, PSTN, or wireless network) can perform the sequence of instructions in coordination with one another. A computer system can transmit and receive messages, data, and instructions, including program code (i.e., application code) through communication link and communication interface. Received program code can be executed by a processor as it is received, and/or stored in a disk drive, or other non-volatile storage for later execution. In one embodiment, a system may be implemented as a hand-held device. But in other embodiments, a system can be implemented as a personal computer (i.e., a desktop computer) or any other computing device. In at least one embodiment, any of the above-described delivery systems can be implemented as a single system or can be implemented in a distributed architecture including multiple systems.

In other examples, the systems, as described above can be implemented from a personal computer, a computing device, a mobile device, a mobile telephone, a facsimile device, a personal digital assistant (“PDA”) or other electronic device.

In at least some of the embodiments, the structures and/or functions of any of the above-described interfaces and panels can be implemented in software, hardware, firmware, circuitry, or a combination thereof. Note that the structures and constituent elements shown throughout, as well as their functionality, can be aggregated with one or more other structures or elements.

Alternatively, the elements and their functionality can be subdivided into constituent sub-elements, if any. As software, the above-described techniques can be implemented using various types of programming or formatting languages, frameworks, syntax, applications, protocols, objects, or techniques, including C, Objective C, C++, C#, Flex™, Fireworks®, Java™, Javascript™, AJAX, COBOL, Fortran, ADA, XML, HTML, DHTML, XHTML, HTTP, XMPP, and others. These can be varied and are not limited to the examples or descriptions provided.

In at least some of the embodiments, the structures and/or functions of any of the above-described interfaces and panels can be implemented in software, hardware, firmware, circuitry, or a combination thereof. Note that the structures and constituent elements shown throughout, as well as their functionality, can be aggregated with one or more other structures or elements.

The foregoing description of various embodiments of the claimed subject matter has been provided for the purposes of illustration and description. It is not intended to be exhaustive or to limit the claimed subject matter to the precise forms disclosed. Many modifications and variations will be apparent to the practitioner skilled in the art. Embodiments were chosen and described in order to best describe the principles of the invention and its practical application, thereby enabling others skilled in the relevant art to understand the claimed subject matter, the various embodiments and the various modifications that are suited to the particular use contemplated.

What is claimed is:

1. A system comprising:
a measurement device configured to perform measurement associated with one or more features of a part and to generate a plurality of measured data; and
a processor configured to:
a) receive the plurality of measured data,
b) receive manufacturing specification data associated with the part,
c) receive precision data associated with confidence level for inspection of the part,
d) perform a sequential model-based optimization by generating a surrogate function using the plurality of measured data and the manufacturing specification data, wherein an acquisition function based on the sequential model-based optimization of the surrogate function identifies a region associated with the part to be inspected in a next iteration,
e) transmit control data associated with the region to cause the measurement device to perform measurements in the next iteration, and
f) repeating steps (d) and (e) until an error exceeding a threshold specified in the manufacturing specification data is found or until the confidence level is reached.

2. The system of claim 1, wherein the measurement device is one or more of a laser scan device and a coordinate measuring machine.

3. The system of claim 1, wherein an initial surrogate function is generated based on the plurality of measured data using a laser scan device.

4. The system of claim 3, wherein subsequent measurements of the region is performed by a coordinate measuring machine.

5. The system of claim 1, wherein an initial surrogate function is generated based on the plurality of measured data using a coordinate measuring device.

6. The system of claim 1, wherein the part is being inspected post manufacturing of the part.

7. The system of claim 1, wherein the part is being inspected during a manufacturing process of the part.

8. The system of claim 7, wherein the manufacturing process is one of an additive manufacturing process or a subtractive manufacturing process.

9. The system of claim 1, wherein the confidence level is user selectable.

10. The system of claim 1, wherein the sequential model-based optimization is a Bayesian optimization.

11. A method comprising:
a) performing measurement associated with one or more features of a part to generate a plurality of measured data;
b) receiving the plurality of measured data;
c) receiving manufacturing specification data associated with the part;
d) receiving precision data associated with confidence level for inspection of the part;
e) performing a sequential model-based optimization by generating a surrogate function using the plurality of measured data and the manufacturing specification data, wherein an acquisition function based on the sequential model-based optimization of the surrogate function identifies a region associated with the part to be inspected in a next iteration,
f) transmitting control data associated with the region to cause a measurement device to perform measurements in the next iteration; and
g) repeating steps (e) and (f) until an error exceeding a threshold specified in the manufacturing specification data is found or until the confidence level is reached.

12. The method of claim 11, wherein the measurement device is one or more of a laser scan device and a coordinate measuring machine.

13. The method of claim 11, wherein an initial surrogate function is generated based on the plurality of measured data using a laser scan device.

14. The method of claim 13, wherein subsequent measurements of the region is performed by a coordinate measuring machine.

15. The method of claim 11, wherein an initial surrogate function is generated based on the plurality of measured data using a coordinate measuring machine.

16. The method of claim 11, wherein the part is being inspected post manufacturing of the part.

17. The method of claim 11, wherein the part is being inspected during a manufacturing process of the part.

18. The method of claim 17, wherein the manufacturing process is one of an additive manufacturing process or a subtractive manufacturing process.

19. The method of claim 11, wherein the confidence level is user selectable.

20. The method of claim 11, wherein the sequential model-based is a Bayesian optimization.
